(19) United States
(12) Patent Application Publication
(10) Pub. No.: US 2010/0233917 A1
(43) Pub. Date: Sep. 16, 2010

(54) FIXTURE DEVICE FOR CABLE ELEMENTS

(75) Inventor: Jens Jorren Sorensen, Kovenhavn S (DK)

Correspondence Address: Perman & Green, LLP, 99 Hawley Lane, Stratford, CT, 06614, US

(73) Assignee: LAKEFARM HOLDING APS, Frederiksberg (DK)

(21) Appl. No.: 12/664,739

(22) PCT Filed: Aug. 8, 2008
(86) PCT No.: PCT/IB08/02113

§ 371 Date: May 26, 2010

(30) Foreign Application Priority Data
Jun. 27, 2007 (DK) PA200700936

(51) Int. Cl. H01R 4/02; H01R 13/02; B29C 45/14

(52) U.S. Cl. 439/874; 439/884; 264/272.11

(57) ABSTRACT

A cable fixture device for routing at least one cable element from a first location on the cable fixture device to a second location on the cable fixture device is provided. The cable fixture device includes a strip element and a plurality of pin elements disposed on at least one surface of the strip element. Each of the plurality of pin elements includes a stem element and a head element. The stem element of the each pin element is attached to the strip element. Further, each pin element is capable of elastic deformation and the at least one cable element is routed through the plurality of pin elements. The head elements of the plurality of pin elements prevent disengagement of the at least one cable element from the cable fixture device.

### CROSS-REFERENCE TO RELATED APPLICATIONS

This application is the National Stage of International Application No. PCT/IB2008/002113 International Filing Date, 8 Aug. 2008, which designated the United States of America, and which International Application was published under PCT Article 21 (2) as WO Publication No. WO2009/001215 A2 and which claims priority from Danish Application No. PA200700936 filed on 27 Jun. 2007, the disclosures of which are incorporated herein by reference in their entireties.

### BACKGROUND

1. Field

The disclosed embodiments relate, generally, to the field of fixture devices, and more specifically, to a fixture device for the cable elements.

2. Brief Description of Related Developments

The use of cable elements is widespread in both domestic and industrial applications. Examples of cable element include, but are not limited to, electrical cables, communication links, connectors and data cables. The domestic applications of cable elements include, but are not limited to, their use in buildings and offices to connect various devices, for example, printers, computers, lamps, loudspeakers and other electrical utilities. The industrial applications of cable elements include, but are not limited to, power supply, electrical control systems and communication links.

In a typical office, home or industrial environment, various electrical, electronic and communication devices are required to be connected with power sources and/or with each other. With an increasing use of such devices, the number of corresponding cable elements also increases. This can results in a possibly dangerous tangle of cable elements. People may stumble on the cable elements that are placed to freely hang along the walls or rest on frequently used places and articles, like the floor and work-table, provide a risk for accidents. Further, such an arrangement of cable elements also presents a bad appearance, for example, the cable elements may be visible on tables, floor, ceiling or walls. Moreover, such an arrangement of cable elements also poses hindrance in cleaning.

The art of coiling, fixing and routing the cable elements in an orderly manner is termed as cable management. The quality of a cable management system depends, primarily, on its versatility and user-friendliness.

In one of the existing techniques of cable management, the cable elements are shortened, to a desired length, by coiling them and securing the coil by using a string. The string can be made of rope, plastic, Velcro® or a similar material. By this technique, the free hanging of cable elements can be prevented. However, this technique is not suitable for the cable elements that are suspended along a vertical surface like a wall. To apply this technique for such cable elements, the coil needs to be supplemented with fasteners, like nails, to keep the coil attached to the vertical surface. Application of nails can leave holes or marks on the vertical surface when the cable elements need to be dismounted or replaced. Moreover, the coil may get damaged during the dismounting process.

In another technique, a cable-net is used. The cable-net has a rigid base and a flexible cable support, like a net. The flexible cable support is used to contain the excess length of the cable elements running between two nodes, for example, an electrically operated device and a power source. Application of the cable-net technique requires a large space. Moreover, when this technique is used with cable elements suspended along vertical surfaces, the cable elements loosen over time. The cable elements that fall out of the cable-net, after loosening, can lead to accidents.

In another technique, a cable holder is comprised of a strip-shaped plate with a number of taps on one side of the strip. Each tap comprises one shaft and one head where the height of a shaft, the distance between two shafts as well as the free space between two heads all are larger than the diameter of the cables. The taps are not of a flexible material so the free space between the heads needs to be larger than the diameter of the cable to enable the cable to be mounted and removed. This means that this concept has a marginal locking effect on the cable so that the cable can easily fall down if subjected to vibrations, there is not an appealing sound when the cable is mounted as there is snapping sound. Further, the rigid taps may hurt the cables if they are removed quickly. The rigid taps makes the cable holder less usable for of different diameter.

In yet another technique, a slit-perforated sheet is used. This sheet can be permanently attached to a surface and the cables can be passed through the slits is only limited to the placing of the slits. However, once the system is mounted it is difficult to apply the cables especially on those areas that are difficult to reach. Moreover, if the cables have to be applied before the mounting of the system, it is a very tedious work and requires a lot of planning.

In light of the foregoing discussion, there is a need for a cable fixture device for efficiently routing the cable elements from one location to other location. Moreover, the fixture device should be suitable for being used with any type of the surface. Further, mounting and dismounting of the cable elements from the fixture device should be simple and easy. Furthermore, the cable fixture device should provide a means for coiling up the excess length of the cable element.

### SUMMARY

An object of the disclosed embodiments is to provide a cable fixture device to route at least one cable element from a first location on the fixture device to a second location on the fixture device, and avoid the problems that the various types of fixture devices discussed above are prone to.

Another object of the disclosed embodiments is to provide a cable fixture device for coiling up the excess length of cable element.

Another object of the disclosed embodiments is to provide a cable fixture device, where the mounting and dismounting of the cable element does not necessarily require a force to be applied in a direction that is perpendicular to the cable fixture device. The disclosed embodiments enable mounting and dismounting by applying a force in a direction that is parallel to the cable fixture device making it easy to route cable element under most circumstances.

Yet another object of the disclosed embodiments is to provide a cable fixture device in which the cable element can enter and exit the cable fixture at any point along the perimeter of the cable fixture plate.

Yet another object of the disclosed embodiments is to provide a cable fixture device that can be used for routing multiple cable elements simultaneously. These cable elements may cross each other providing a large degree of flexibility.

Yet another object of the disclosed embodiments is to provide a cable fixture device that can absorb vibrations and mechanical impacts.

Yet another object of the disclosed embodiments is to provide a cable fixture device that allows dissipation of heat from the cable elements.

Yet another object of the disclosed embodiments is to provide a cable fixture device for non-planar routing of the cable elements.

To achieve the foregoing objects of the disclosed embodiments, a cable fixture device for routing at least one cable element from a first location on the cable fixture device to a second location on the cable fixture device is provided. The cable fixture device comprises a strip element; and a plurality of pin elements disposed on at least one surface of the strip element. Each of the plurality of pin elements comprises a stem element and a head element. The stem element of the each pin element is attached to the strip element. The height of the stem element of each pin element is at least equal to a diameter of the at least one cable element. Each pin element is capable of elastic deformation. The gap between a first stem element corresponding to a first pin element and an adjacent stem element corresponding to an adjacent pin element is at least equal to a diameter of the at least one cable element. Moreover, the gap between a first head element corresponding to the first pin element and an adjacent head element corresponding to the adjacent pin element is less than the diameter of the at least one cable element. The at least one cable element is routed between the first pin element and the adjacent pin element. The first head element and the adjacent head element prevent disengagement of the at least one cable element from the cable fixture device.

Other features and advantages of the disclosed embodiments will become apparent in the description.

### BRIEF DESCRIPTION OF THE DRAWINGS

The preferred embodiments will hereinafter be described in conjunction with the appended drawings that are provided to illustrate and not to limit the disclosed embodiments, wherein like designations denote like elements, and in which:

FIG. 1 illustrates an elevated view of a cable fixture device, in accordance with an aspect of the disclosed embodiments;

FIG. 2 illustrates a bottom view of a cable fixture device, in accordance with an aspect of the disclosed embodiments;

FIG. 3 illustrates a side view of a cable fixture device, in accordance with another embodiment of the present invention;

FIG. 4 illustrates a side view of a cable fixture device, in accordance with yet another aspect of the disclosed embodiments;

FIG. 5 illustrates an application of one or more cable fixture devices, in accordance with an aspect of the disclosed embodiments;

FIG. 6 illustrates an application of a cable fixture device, in accordance with another aspect of the disclosed embodiments;

FIG. 7 illustrates an application of a cable fixture device, in accordance with yet another aspect of the disclosed embodiments;

FIG. 8 illustrates an elevated view of a cable fixture device, in accordance with an aspect of the disclosed embodiments;

FIG. 9 illustrates a bottom view of a cable fixture device, in accordance with an aspect of the disclosed embodiments;

FIG. 10 illustrates a strip element, in accordance with an aspect of the disclosed embodiments;

FIG. 11 illustrates an elevated view of a plurality of pin elements, in accordance with an aspect of the disclosed embodiments;

FIG. 12 illustrates a top view of a plurality of pin elements, in accordance with an aspect of the disclosed embodiments;

FIG. 13 illustrates a moulding unit in a closed position, in accordance with an aspect of the disclosed embodiments;

FIG. 14 illustrates a moulding unit in an open position, in accordance with an aspect of the disclosed embodiments;

FIG. 15 illustrates a closed-mould position of a moulding process, in accordance with an aspect of the disclosed embodiments;

FIG. 16 illustrates an open-mould position of a moulding process, in accordance with an aspect of the disclosed embodiments;

FIG. 17 illustrates a cable fixture device, in accordance with an aspect of the disclosed embodiments;

FIG. 18 illustrates a cable fixture device, without head elements, in accordance with an aspect of the disclosed embodiments;

FIG. 19 illustrates a top view of a cable fixture device, in accordance with yet another aspect of the disclosed embodiments a cable fixture device, in accordance with yet another aspect of the disclosed embodiments;

FIG. 21 illustrates a cable fixture device, in accordance with yet another aspect of the disclosed embodiments;

FIG. 22 illustrates a cross-sectional view of stem element, in accordance with yet another aspect of the disclosed embodiments;

FIG. 23 illustrates a bottom view of a cable fixture device, in accordance with yet another aspect of the disclosed embodiments;

FIG. 24 illustrates a side view of a cable fixture device, in accordance with an aspect of the disclosed embodiments;

FIG. 25 illustrates a top view of a cable fixture device, in accordance with another aspect of the disclosed embodiments;

FIG. 26 illustrates a moulding unit for manufacturing of cable fixture device in accordance with an aspect of the disclosed embodiments;

FIG. 27 illustrates an exploded view of moulding unit for manufacturing of the cable fixture device in a top view in accordance with an aspect of the disclosed embodiments; and

FIG. 28 illustrates an exploded view of moulding unit for manufacturing the cable fixture device in a bottom view in accordance with an aspect of the disclosed embodiments.

### DETAILED DESCRIPTION OF THE DISCLOSED EMBODIMENTS

While the preferred embodiments have been illustrated and described, it will be clear that the embodiments are not limited to these embodiments only. Numerous modifications, changes, variations, substitutions and equivalents will be apparent to those skilled in the art, without departing from the spirit and scope of the disclosed embodiments, as described in the claims.

Selected embodiments will now be explained with reference to the drawings. It will be apparent to those skilled in the art from this disclosure that the following description of the disclosed embodiments are provided for illustration only, and not for the purpose of limiting the disclosed embodiments, as defined by the appended claims.

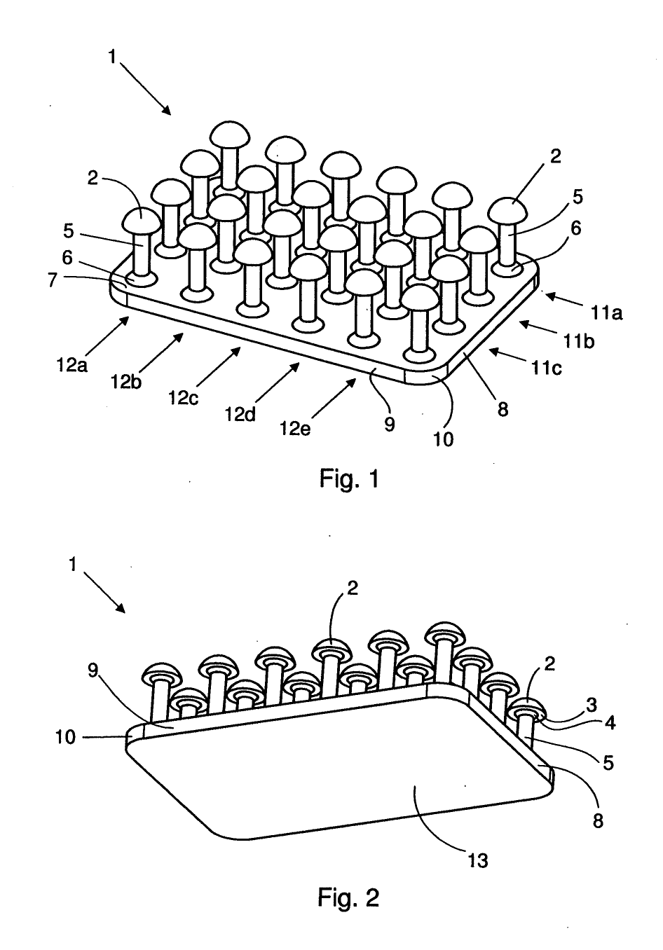

FIGS. 1 and 2 illustrate a cable fixture device in accordance with an aspect of the disclosed embodiments. FIG. 1 illustrates an elevated view and FIG. 2 illustrates a bottom view of the cable fixture device. The cable fixture device includes a strip element and a plurality of pin elements disposed on at least one surface of the strip element. In an exemplary scenario, both the surfaces of the strip element can have pin elements disposed over them. The plurality of pin elements are elastically deformable. The plurality of pin elements are used to route the at least one cable element. The cable elements can be routed through the gaps between the plurality of pin element. Further, the plurality of pin elements resists a separation of the cable element from the cable fixture device.

The cable fixture device (1), shown as an example, illustrates a small portion of the cable fixture device to be used for routing cable elements. Examples of cable element include, but are not limited to, electrical cables, communication links, connectors and data cables. The cable fixture device (1) includes a strip element described by the surfaces (7, 8, 9, 10, and 13). Further, the cable fixture device (1) includes a plurality of pin elements. Each pin element includes a cylindrical stem element (5) and a hemispherical shaped head (2). In an embodiment, a socket (6) can be provided at the interface between the stem element (5) and the strip element. Further, another socket (4) can also be provided at the interface of the back (3) of the head and the stem element (5). The sockets (4 and 6) are provided to impart strength to the pin element. For example, the socket (4) is added to prevent the ripping-off of the head (2) when the cable fixture device (1) is in use. In an arrangement, the plurality of pin elements are disposed on the strip element in a two-dimensional array.

In an aspect of the disclosed embodiments, the strip element and the plurality of pin elements are formed of the same material. In another aspect of the disclosed embodiments, the strip element and the plurality of pin elements can be made of different materials.

In one arrangement, either or both of the strip element and plurality of pin elements are made up of a resilient material. Further, in another arrangement, the pin elements and/or the strip element is made up of a transparent or a translucent material. Furthermore, in another embodiment, the strip element can be made of aluminium.

In another arrangement, either or both of the strip element and plurality of pin elements are made up of a material that does not support static charge.

In an embodiment, either or both of, the strip element and the plurality of pin elements are made up of a plastic material. The abovementioned plastic material encompasses all those materials that are capable of being injection moulded, and being ductile enough for bending the pin elements when mounting a cable element between them. Examples of plastic material include, but are not limited to, polyethylene (PE), polypropylene (PP), vinyl chloride polymers (PVC), polycarbonates (PC), polyethylene terephthalate (PET), acrylonitrile butadiene styrene (ABS), polyamide (PA).

In another embodiment, the material for either or both of the strip element and the plurality of pin elements has a modulus of elasticity (E) ranging from E≈2000 N/mm² to E≈3500 N/mm²

To illustrate the application of the cable fixture device (1), an exemplary embodiment is explained below. A cable element can be routed through at least one of the three gaps (11a, 11b, 11c), in a first direction, formed between the pin elements. The cable elements can also be routed through one of the five gaps (12a, 12b, 12c, 12d, 12e) in a second direction that is shown to be perpendicular to the first direction.

In another exemplary application, the cable element can enter through a gap in the first direction, take a turn around a pin that is adjacent to the gap, and exit the cable fixture device from a gap in a second direction. For example (not shown in figure), the cable element can, make its entrance in gap (11b) and make its exit at gap (12c). In another aspect of the disclosed embodiments, the cable element can be routed in all directions, including diagonal directions.

When only one side of the strip element has the plurality of pin elements (as illustrated in the FIG. 1), an adhesive layer can be applied over the back surface (13) of the strip element. In this arrangement, the strip element can be attached to a surface. Examples of the surface include, but not limited to, table tops, chassis of a machine, walls, and vertical panels. In another arrangement of the disclosed embodiments, the cable fixture device (1) can be attached by a variety of attaching means, for example, screws, bolts, rivets, snaps, hook-and-loop fasteners, silicone, tape, clips, and nails.

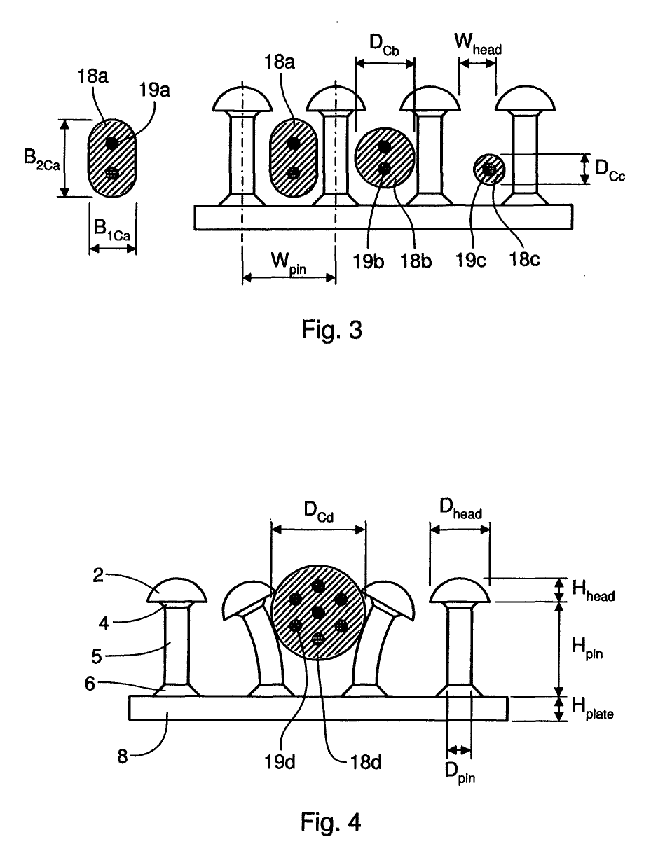

FIGS. 3 and 4 illustrate side view of a cable fixture device, in accordance with another aspect of the disclosed embodiments. This figure describes an exemplary scenario of routing the cable elements having different cross-sectional diameters by using the cable fixture device (1). Each of the three gaps (11a, 11b, 11c) is shown to route the cable elements. The three gaps (11a, 11b, 11c) route the cable elements (18a, 18b, 18c) respectively. The cable elements (18a, 18b, 18c) can be the commonly used household cables having different diameters. In an exemplary scenario, the cable element (18a) is a non circular double core electrical cable with dimensions approximately ranges from B_{1Ca}×B_{2Ca}≈3 mm×5 mm and. 4 mm×6 mm. Further, the cross-sectional diameters of the cable elements range from ø3 mm to ø9 mm.

The cable fixture device (1) is used to route the cable elements for a computer system in an exemplary scenario. The cable elements includes a cable connecting computer and the mouse having a diameter of 3 mm, a universal Serial Bus(USB) cable having a diameter of 4 mm, a printer cable with 9 mm diameter, a cable connecting the computer and the monitor of 8 mm diameter and electrical cables for common power tools of approximately 7 mm diameter. Thus, the cable fixture device (1) is use to route cable elements ranging in diameters from 3 mm to 9 mm. The height of the pin elements (4, 5, 6) is approximately about 9 mm. The diameter of each pin is chosen to be approximately Dₚᵢₙ≈2 mm. The width between the pin elements (2, 4, 5, 6) turns out to be Wₚᵢₙ≈11 mm. The space between the head element (6) of the plurality of pin elements (2, 4, 5, 6) has to be a little smaller than the smallest cable element (18c) diameter D_{Cc}≈3 mm. Thus W_{head}≈2.5 mm is chosen as the space between the heads of pin elements (2, 4, 5, 6) to prevent the smallest cable element (18c) to drop out of the cable fixture device (1), if it has to be placed upside down. The diameter of the head element (6) of the pins would be approximately D_{head}=Wₚᵢₙ−W_{head}≈8.5 mm. A cable element (18d) having a cross-sectional diameter D_{Cd}≈13 mm, more than the space between the head elements (6), can also be placed between the pin elements.

In an embodiment, the height of the pin elements ranges from 1 millimeter (mm) to 100 mm.

Further, in an exemplary arrangement, the ratio of the height of the pin element to the diameter of the stem element (5) ranges from 1:1 to 10:1.

In another aspect of the disclosed embodiments, the cable elements having cross-sectional diameter less than the space between the heads of the pin elements, can be routed using the cable fixture device by making some crossing or zigzag of the cable element between the pin elements. In another embodiment, the cable elements having cross-sectional diameter less than the space between the heads of the pin elements, can be routed using the cable fixture device by making small loops around some of the pin elements.

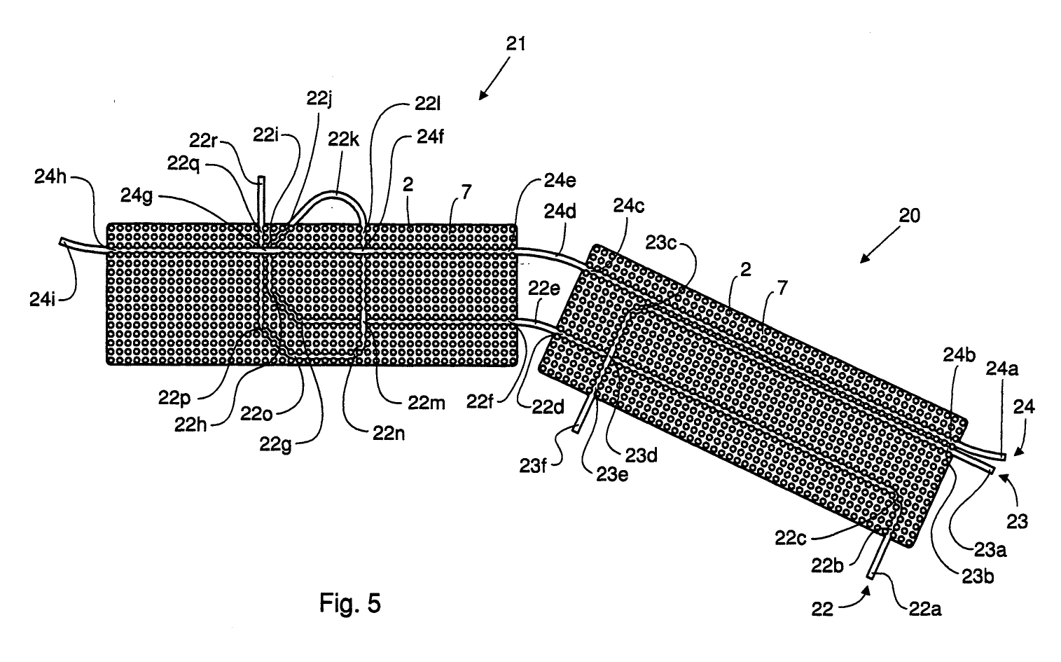

FIG. 5 illustrates an application of one or more cable fixture devices, in accordance with an aspect of the disclosed embodiments. FIG. 5 describes an exemplary scenario of routing the cable elements using two cable fixture devices (20, 21). The two cable fixture devices (20, 21) are placed on a plane surface inclined with each other. A cable element (22) starts from the side of the cable fixture device (20) at (22a). The cable element (22) then makes an entrance at (22b) and then bends at (22c) at cable fixture device (20). Then, the cable element (22) leaves the cable fixture device (20) at (22d). Further, the cable element (22) makes a new entrance on cable fixture device (21) at (22f). Between the entrance (22f) and the exit (22q) in the cable fixture device (21), the cable element (22) makes a loop (22g, 22h, 22i, 22j, 22k, 22l, 22m, 22n). At (22m), the cable element (22) bend upward and over, like a bridge. The cable element (22) go through diagonal gaps from (22o) to (22p) and from (22c) to (22h).

Another cable element (23) has its entrance at the end of cable fixture device (20) at (23b), make a corner at (23c). The cable element (23) makes a jump over cable element (22) at (23d), to exit the cable fixture device (21) from the cable fixture device (20) at (23e). In another aspect of the disclosed embodiments, a cable element can pass a cable fixture device diagonally completely throughout from one side to the other in a variety of ways.

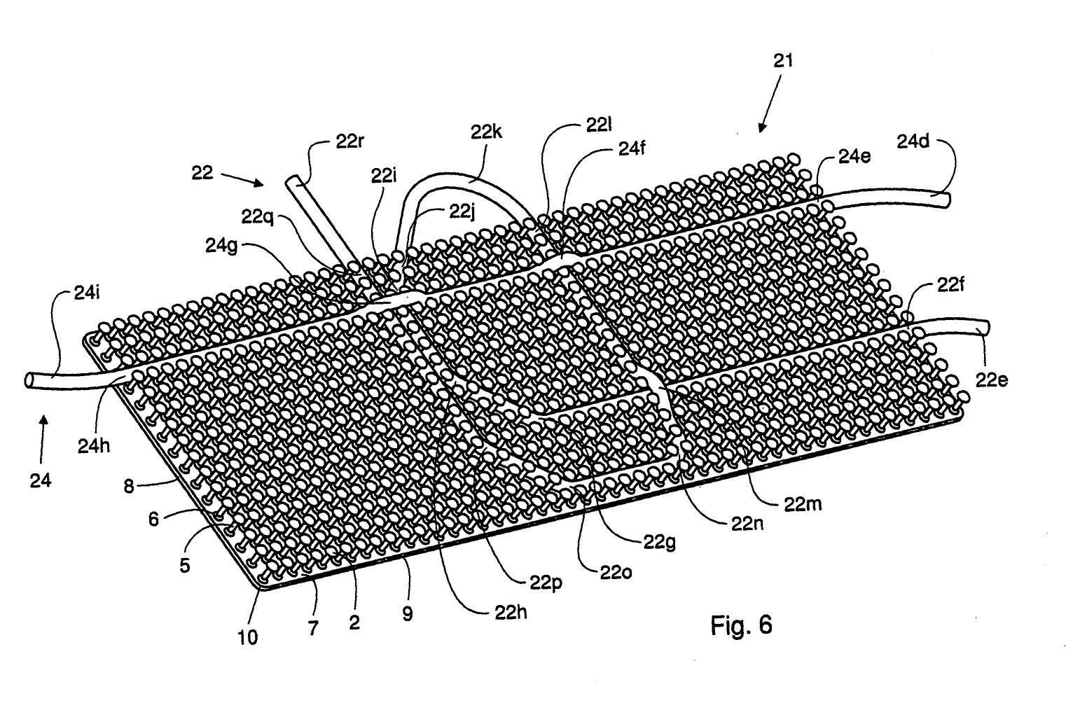

FIG. 6 illustrates an application of a cable fixture device, in accordance with another aspect of the disclosed embodiments. A cable element (24) has its entrance at the end of cable fixture device (20) at (24b). The cable element (24) exits the cable fixture device (20) at (24c) and makes an entrance at (24e) on the cable fixture device (21). The cable element (24) then goes straight through the cable fixture device (21) and exit at the end at (24h). The cable element (24) has to cross the cable element (22) in an upward bend at (24f) and cross the cable element (22) in an upward bend at (24g).

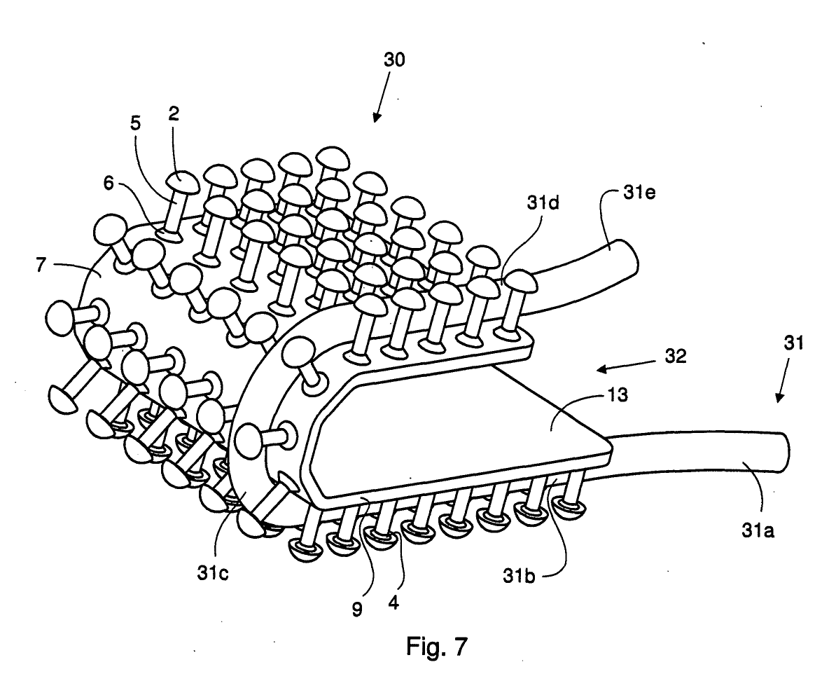

FIG. 7 illustrates a cable fixture device in accordance with yet another aspect of the disclosed embodiments. The cable fixture device (30) is illustrated to be placed on an edge (32) of a surface (not shown in figure). Example of a surface includes, but not limited to a table top, a wall and a panel. The cable fixture device (30) is deformed to conform to the shape of the surface. The material of the strip element is resiliently deformable. This allows non-planar routing of the cable element (31) using the cable fixture device (30). A portion of the cable fixture device (30) is attached to the upper surface of the edge (32) such that back surface (13) of the strip element mates a top surface of the edge (32). Similarly, another portion of the cable fixture device (30) is attached to a lower surface of the edge (32). The cable element (31) begins from the lower part of the cable fixture device at (31a), make an entrance at (31b), bend at (31c) along the cable fixture device (30) and leave the cable fixture device (30) at (31d). In another aspect of the disclosed embodiments, the cable fixture device can be deformed in to a configuration to facilitate three dimensional routing of the cable elements.

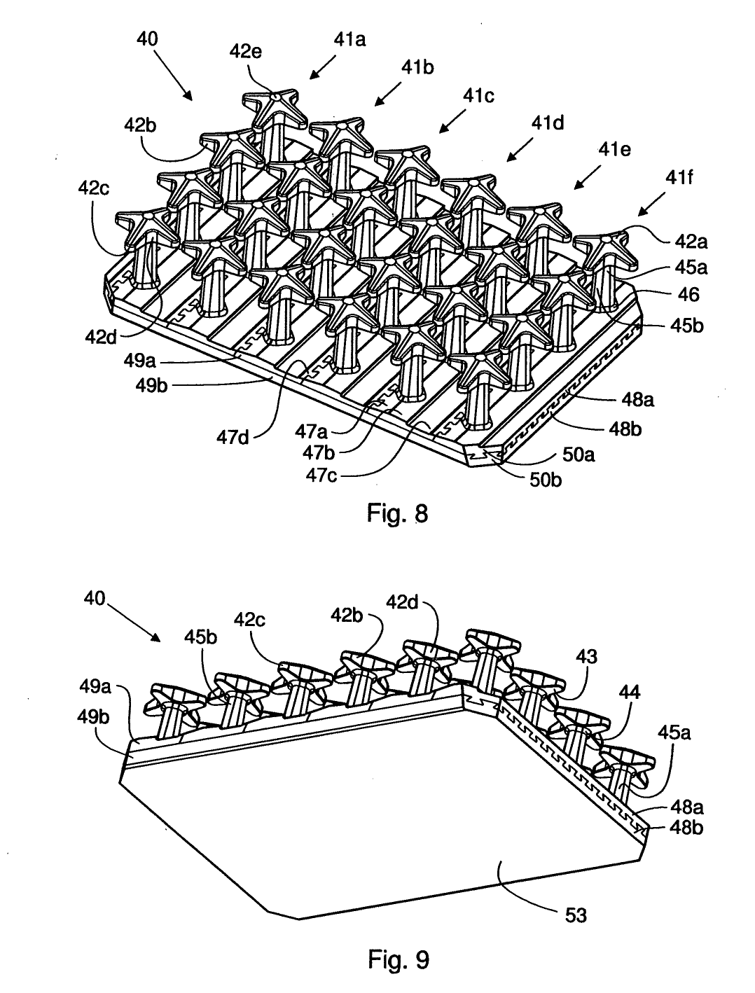

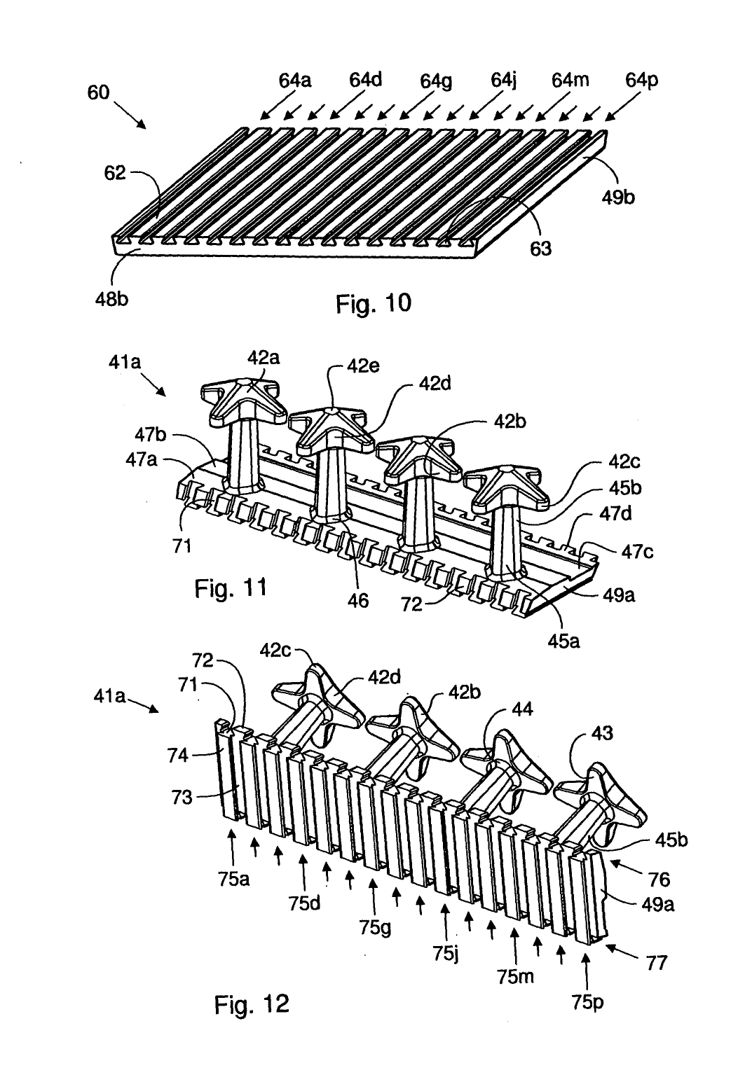

FIGS. 8 and 9 illustrate a cable fixture device (40), in accordance with an aspect of the disclosed embodiments. The details of the cable fixture device 40 are explained in conjunction with the FIGS. 10, 11, and 12.

FIG. 10 illustrates a strip element in accordance with the embodiment illustrated in the FIGS. 8 and 9. Grooves are formed on one of the surfaces of the strip element. For example, the grooves (64a to 64p) are shown to be formed on the top surface of the strip element (60). Each groove has a groove bottom-surface (63) and a top gap (62), whose width is smaller than the groove bottom-surface (63). An exemplary method of manufacturing the strip element (60) is extrusion. In one of the aspects of the disclosed embodiments, the material of the strip element (60) can be plastic. Examples of the plastic material include, but not limited to, polyethylene (PE), polypropylene (PP), vinyl chloride polymers (PVC), polycarbonates (PC), polyethylene terephthalate (PET), acrylonitrile butadiene styrene (ABS) and polyamide (PA). In another embodiment, the material for the strip element (60) is aluminium. Further, the strip element can be extruded in the form of long sheets or rolls and then cut into the desired size and shape.

FIGS. 11 and 12 illustrate the plurality of pin elements in an elevated view and top view respectively in accordance with the embodiment illustrated in FIGS. 8 and 9. In this embodiment, the plurality of pin elements is formed in the form of rows (41a) of pin elements. Each pin element includes a socket (46) and a cross shaped head described by the surfaces (42a, 42b, 42c, 42d). The row of pin element (41a) includes a base described by a plurality of surfaces (47a, 47b, 47c, 47d) and the surfaces (48a, 48b, 49a, 49b, 50a, 50b, 53). Further, the bottom surface (73) of the base has a plurality of rails (75a to 75p). Each rail (75a to 75p) projects out of the bottom surface and ends at a free surface (74). The width of the free surface (74) is greater than the width of the joint from where each rail (75a to 75p) projects outwards. The width of the free surface (74) corresponds to the groove bottom-surface (63) of groove. The rows (41a) of pin elements can be attached to the base (60) by sliding the rails into the (75a to 75p) grooves (64a to 64p).

Further, for joining the rows of pin elements with each other, small projections can be provided on lateral surfaces of the rows (41a). For example, the row (41a) in FIGS. 11 and 12 is shown to include small projections (76) projecting from the lateral surface. The small projections are placed in the direction (76). Each small projection (76) has a projection bottom-surface (71) and a projection top-gap (72), which is smaller than the projection bottom-surface (71). Similarly, the opposite lateral surface of the row of pin element (41a) is shown to have small projections (77). The small projections (76) and (77) are so manufactured that when two rows are inserted into the strip element, the small projections (76) of one row mate with the small projection (77) of the adjacent row.

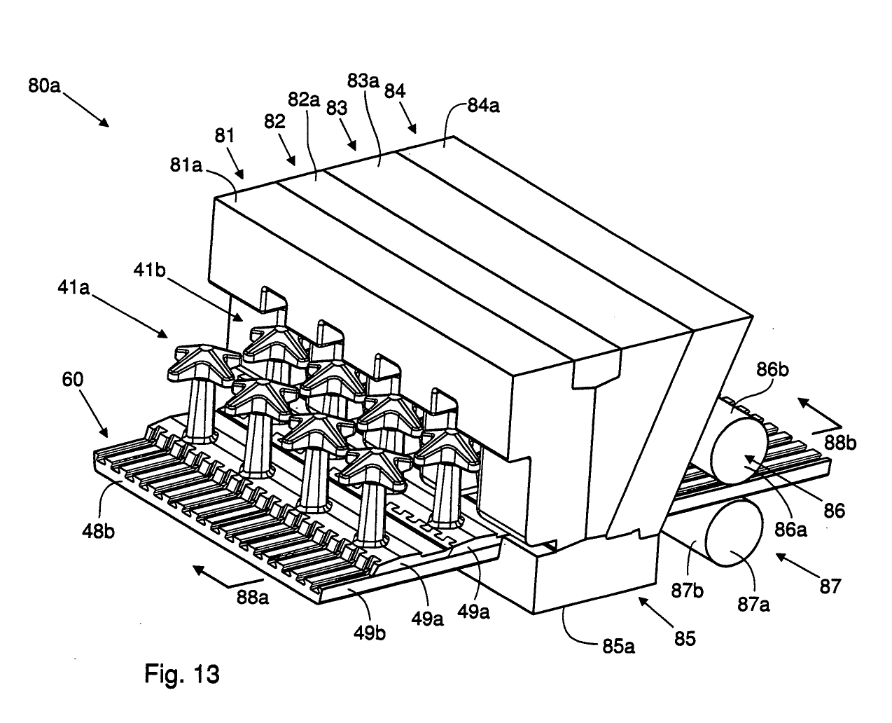

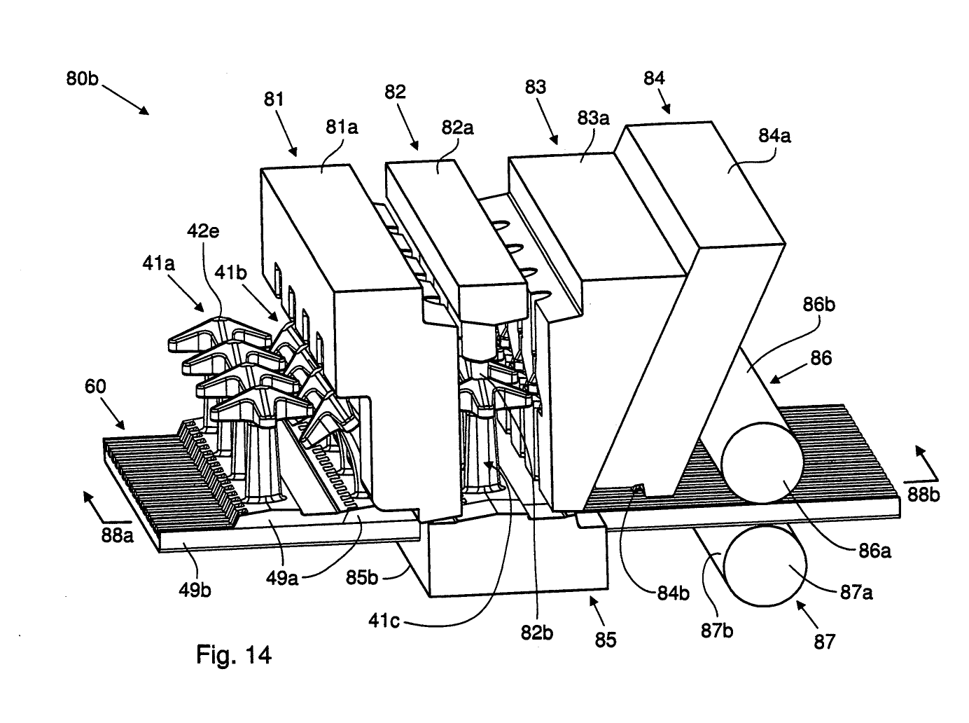

FIGS. 13 and 14 illustrates a moulding unit (80a) in accordance with the embodiment illustrated in FIGS. 8 and 9. The moulding unit (80a) includes first mould part (81) and second mould part (83) responsible for moulding one or more pin elements on either or both the surfaces of the strip element. The moulding unit (80a, 80b), show only the vital parts of the moulding machine. Those skilled in the art will appreciate that the moulding unit (80a) may include all or even a fewer number of components than the components shown in FIGS. 13 and 14. Further, those ordinarily skilled in the art will understand that the moulding unit (80a) may include additional components that are not shown here but are not germane to the operation of the moulding unit (80a) in accordance with the inventive arrangements. To describe the moulding unit (80a), reference will be made to FIGS. 13 and 14, although it will be understood that the moulding unit (80a) can be implemented in any other suitable environment. Each of the mould parts includes half of the cavity. For example, the first mould part (81) includes a first cavity (81c, FIG. 16) and the second mould part (83) includes a second cavity (83c, FIG. 16). The first and second cavities, together, form the cavity that corresponds to the shape of the at least one of the plurality of pin elements. In an example, the cavity can correspond to one pin element. In another example, the cavity can correspond to a row of pin elements.

In an exemplary scenario the rows of pin elements are sequentially moulded, i.e., a second row is (41b) is moulded after moulding a first row (41a). For such a scenario, the outer side of the first mould part (81) includes void spaces (81b) to give room for the pin elements of a row that just had been moulded.

Further, a sliding tool part (84) is provided to mould the small projections (76 and 77). The sliding tool part (84) is attached to the second mould part (83). The sliding tool part (84) makes a slanted movement along an outer surface of the second mould part (83) when it is still attached to the mould part (83).

Further, a bottom tool part (85) can also be provided. The bottom tool part (85) guides the strip element (60) and also forms a side of the cavity. Further, the moulding unit (80a, 80b) also includes two rollers (86, 87) that move the strip element (60) after moulding one row of the pin elements. For example, to move the strip element towards left, (as seen in the plane of the FIGS. 13 and 14) after completing the moulding of the row 41b, the top roller (86) rotates in the clockwise direction about an axis passing through the centre of the surface (86a), and the bottom roller (87) rotates in a counter clockwise direction about an axis passing through the centre of the surface (87a).

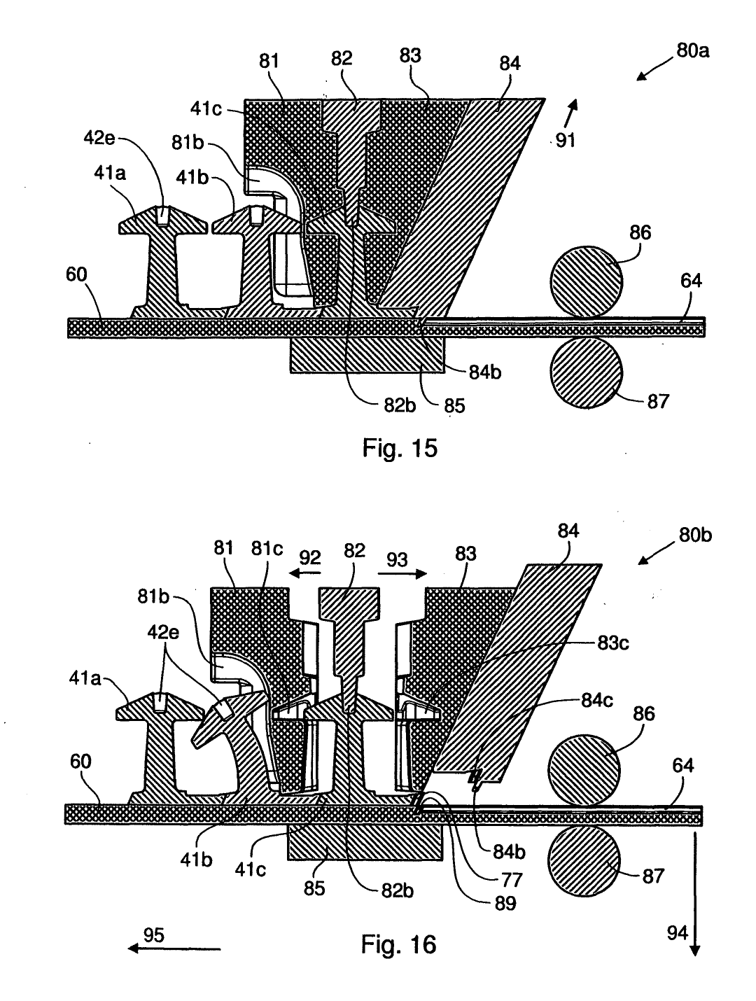

FIGS. 15 and 16 illustrates a moulding process of cable fixture device (40) in accordance with the embodiment illustrated in FIGS. 8 and 9. The moulding method includes mating the first and second mould part to define a cavity. The cavity corresponds to the shape of the at least one of the plurality of pin elements. For the purpose of this description, the cavity is described to correspond to a row of the pin elements. Thereafter, the material of the pin elements is injected in to the cavity. Examples of material include, but not limited to, polyethylene (PE), polypropylene (PP), vinyl chloride polymers (PVC), polycarbonates (PC), polyethylene terephthalate (PET), acrylonitrile butadiene styrene (ABS) and polyamide (PA). The first and the second mould parts are disengaged by moving at least one of the first and second mould parts after the row of pin elements is formed. Further, a stationary part (82) is provided to retain the newly moulded pin elements at their location while the first and the second mould parts are getting disengaged. The stationary part (82) includes needles (82b) corresponding to the pin elements of the row. Each needle (82b) is fitted into a hole (42e) in the corresponding pin element.

When the moulding unit is completely open and the newly moulded row of pin elements is released from the mould, the strip element is automatic pulled leftwards to a new position, such that another row of pin elements can be moulded. Thereafter, the mould is closed again for next moulding cycle.

When a new row of pin elements (41c) is ready for moulding, the first and second mould parts (81, 83) and the sliding (84), bottom (85) and stationary (82) tool parts close to form the cavity. The plastic material is, then, injected through an inlet (not shown). The plastic material is limited by the inside surfaces of the cavity. The small needles (82b) are responsible of the surfaces in the corresponding hole (42e) in each pin element. The surfaces (47a, 47b) of the main body of the row of pin element are also made by corresponding surfaces on the first and second mould parts. The small rails (75a to 75p) on the bottom surface (73) are made and limited by the top of the strip element (60), which contains the small grooves (64a to 64p). The small projections (76) of the lateral surface (72) of the row of pin elements (41c) are made by the corresponding small projections (77) on a trailing rear surface of the row of pin elements (41b). The surfaces (47c, 47d) of the row of pin elements (41c) are made by the corresponding surfaces of the sliding tool part (84).

After completing the moulding process, the moulding unit is opened. The opening sequence starts with the sliding tool part (84) opening in the direction (91). Thereafter, the front mould part (81) moves to the left along the direction (92), and the rear mould part (83), including the sliding tool part (84), moves to the right along the direction (93). Further, as shown in the FIG. 16, the pin elements of the row (41b) bend when the first mould part moves towards the left.

In one scenario, the pin element can get stuck in the cavity (81c, 83c) when the first and the second mould parts (81, 83) are moving apart. The pin elements can get damaged during the execution of the next step of the tool opening. The needles (82b) support each pin element by holding the pin element through the corresponding hole (42e).

Thereafter, the bottom tool part (85) and the two rollers (86, 87) move, downward, along the direction (94). Along with the rollers (86, 87) and the bottom tool part (85), the newly formed row of pin elements (41c) also moves downwards.

Thereafter, the top roller (86) now rotates in the clockwise direction and the bottom roller (87) in the counter clockwise direction. Consequently, the newly moulded row of elements moves in the direction (95).

The movement of components of the moulding unit is described with reference to the opening of the moulding unit; however it will be readily apparent to those with ordinary skill in the art that the components will move in an opposite sequence and along opposite directions, than those described hereinabove, while closing the moulding unit.

Although the pin elements are shown to be manufactured on the strip element itself, it will be readily apparent to those with ordinary skill in the art that all or some of the pin elements can be manufactured separately and then joined onto the strip element.

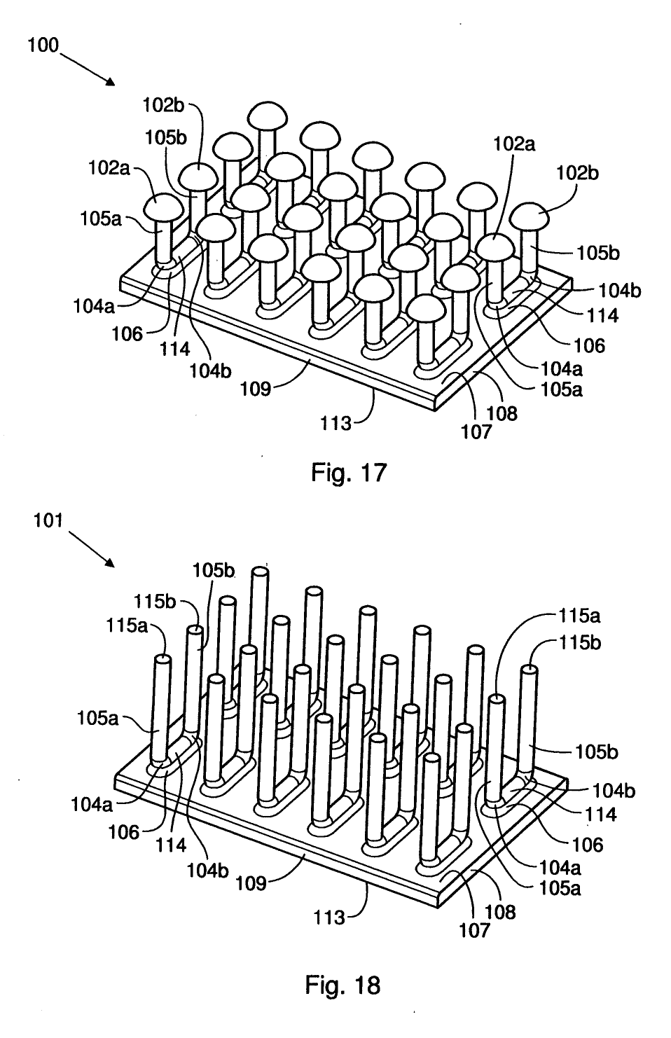

FIGS. 17 and 18 illustrate a cable fixture device (100) in accordance with an aspect of the disclosed embodiments. The cable fixture device (100) includes a strip element described by the surfaces (107, 108, 109, 113) with a plurality of pin elements arranged in a two dimensional array. The plurality of pin elements are made of several rows of paired pin elements. For the purpose of this description, the FIG. 17 is shown to include two rows of paired pin elements. Each paired pin element includes two cylindrical stem elements (105a, 105b) and corresponding hemispherical heads (102a, 102b). Each of the stem elements (105a, 150b) are connected to the corners (104a, 104b) of a horizontal beam (114). The horizontal beam (114) is attached to the strip element. Further, a socket (106) is also shown to be provided to affix the paired pin element to the strip element.

An exemplary process of obtaining the cable fixture device (100) from the structure (101) is detailed below. The structure (101) is a cable fixture device (100) without the head elements. The structure (101) can be placed under a heating plate. The top surfaces (115a, 115b) and the upper part of the stem surfaces (105a, 105b) of the paired pin elements melt due to the heat from the heating plate. Further, a pressure applied through the heating plate can mould the molten portion of the stem elements into head elements. In one arrangement, the shape of the head elements can be controlled by providing corresponding grooves on the heating plate.

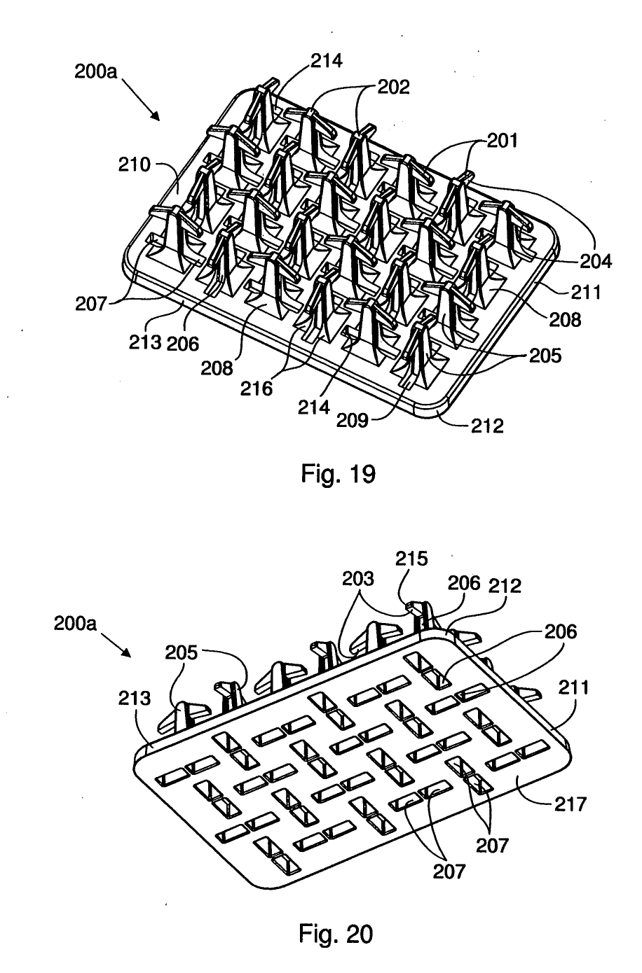

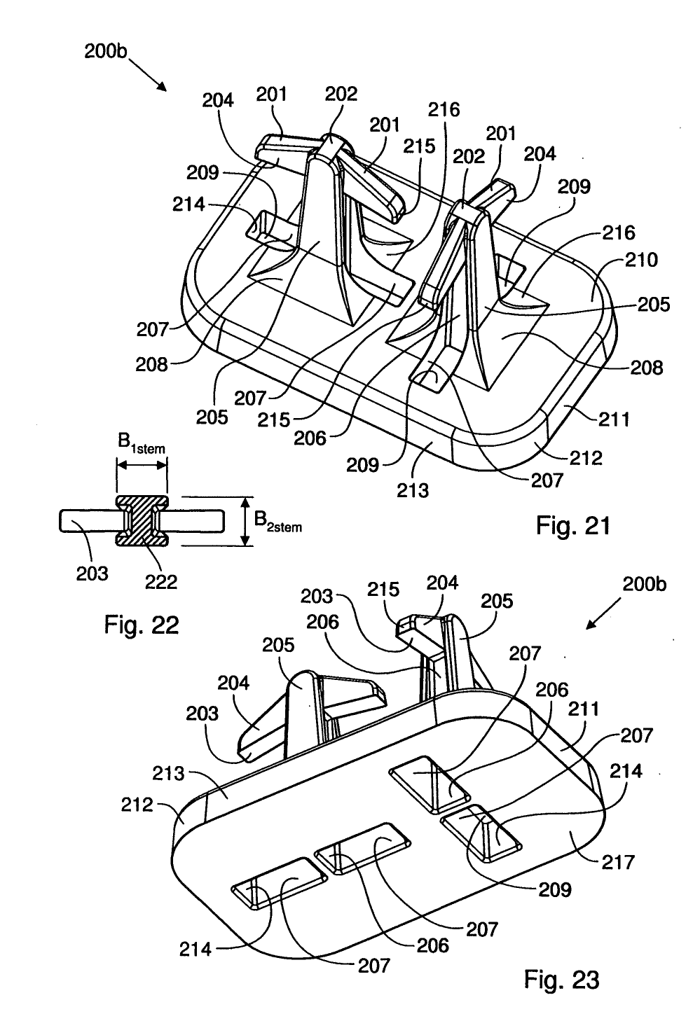

FIGS. 19 to 23 illustrate a cable fixture device (200a), in accordance with yet another aspect of the disclosed embodiments. The cable fixture device (200a) includes a strip element, described by the surfaces (210, 211, 212, 213, 217), and a plurality of pin elements. The plurality of pin elements includes a stem element, described by surfaces (205, 206, 207), and a T-shaped or anchor shaped head, described by the surfaces (201, 202, 203, 204, 215). The stem element has an I-shaped cross section (222, FIG. 22). The stem element is also shown to include sockets 208 and 216. Each side of the pin element is characterized by a hole (209) completely penetrates the strip element. Each hole is defined by the surfaces (206, 207, 214). Further, in this embodiment, the strip element and the pin elements are made of the same material.

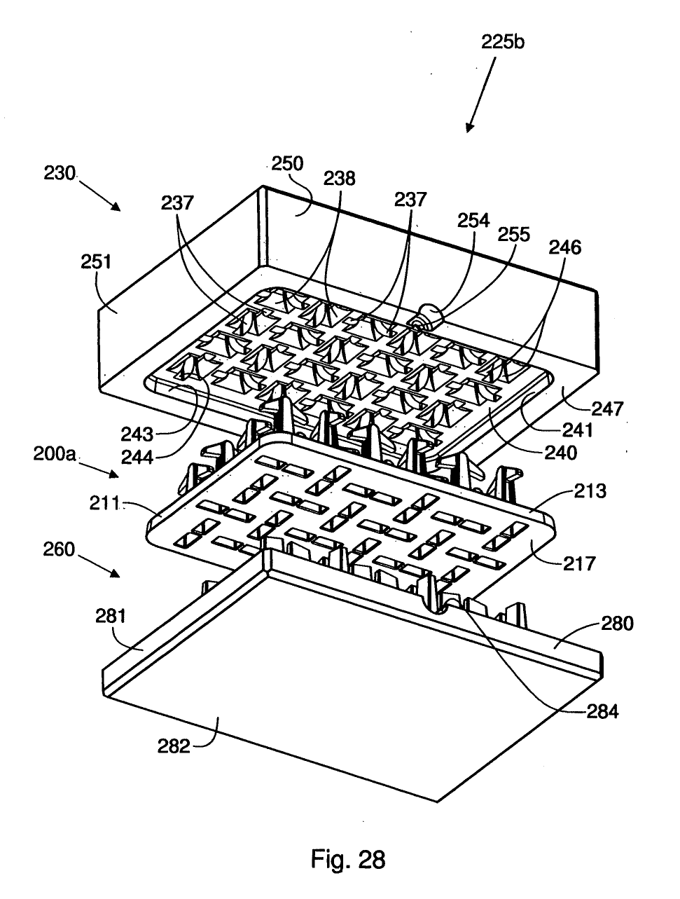

The each pin element is shown to be oriented at right angle to an adjacent pin element in the same row. Further, the exemplary manufacturing process detailed in conjunction with the FIGS. 27 and 28 creates a hole (209) corresponding to each side of the anchor shaped head element of each pin element. The cable fixture device (200a, 200b) is only shown as an example, and is only a portion of a cable fixture device to be used for routing the cable elements. The cable fixture device (200a, 200b) can be used for routing the cable elements as per the arrangements described in conjunction with FIG. 3.

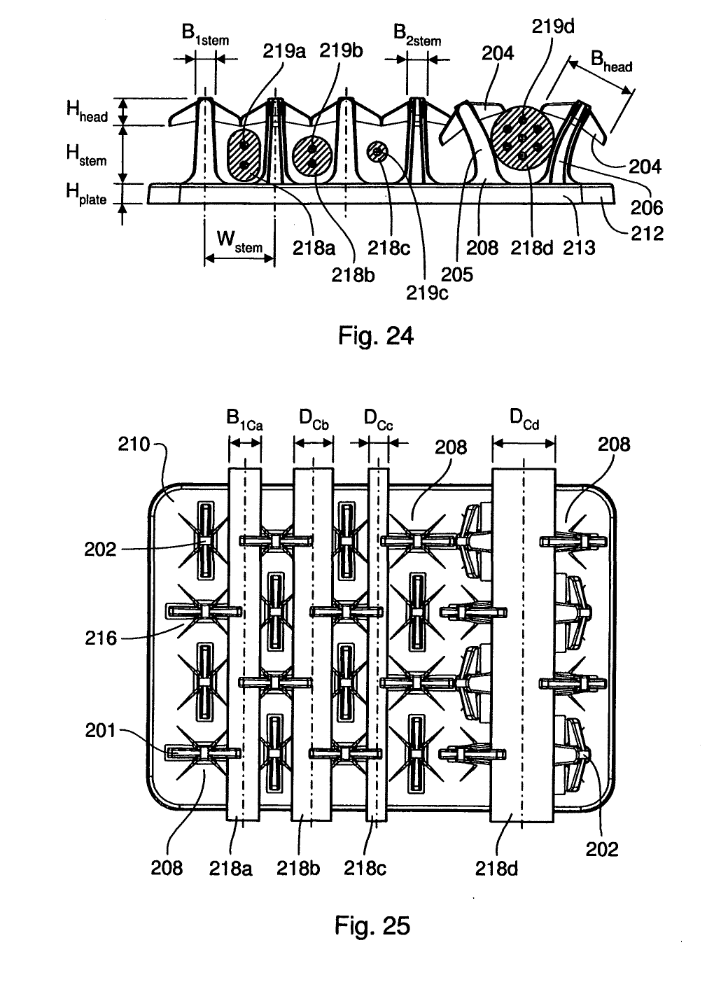

FIGS. 24 and 25 illustrate a cable fixture device in accordance with an aspect of the disclosed embodiments. FIG. 24 illustrates a side view of the cable fixture device and FIG. 25 illustrates a top view of the cable fixture device. An exemplary scenario of routing the cable elements with different cross-sectional diameter using the cable fixture device (200a, 200b) is described. Each of the four gaps is shown to route a cable element. For example, four cable elements (219a, 219b, 219c, 219d), of different diameters, are shown to be routed through the four gaps of the cable fixture device.

An exemplary embodiment to illustrate the routing of cable elements through the cable fixture device (200a) is shown below. In one arrangement, the cable element (219a) is a non circular double core electrical cable whose dimensions range from B_{1Ca}×B_{2Ca}≈3 mm×5 mm and 4 mm×6 mm. In another arrangement, the cable elements can be circular with the cross-sectional diameters ranging from ø3 mm to ø9 mm.

In another arrangement the cable fixture device is used to route the cable elements for a computer system. The cable elements include a cable connecting computer and the mouse having a diameter of 3 mm, a Universal Serial Bus (USB) cable having a diameter of 4 mm, a printer cable with 9 mm diameter, a cable connecting the computer and the monitor of 8 mm diameter, and electrical cables for common power tools of approximately 7 mm diameters. Thus, the cable fixture device is use to route cable elements ranging in diameters from 3 mm to 9 mm. The height of the pins (205, 206, 208) is approximately 9 mm. If the diameter of each pin is chosen to be approximately B₁ₛₜₑₘ×B₂ₛₜₑₘ≈2 mm×2 mm the width between the pin elements (205, 206, 208) turns out to be Wₚᵢₙ≈11 mm. It can be seen that the anchor shaped heads of the pins, with this type of cable plate, has overlapping ends (215), because of the choice of B_{head}>Wₛₜₑₘ. Therefore, even a very small cable would not drop out of the cable fixture plate, if it has to be placed upside down. It is also possible to place a cable element (218d) having a diameter more than the space between the pin heads between the pin elements.

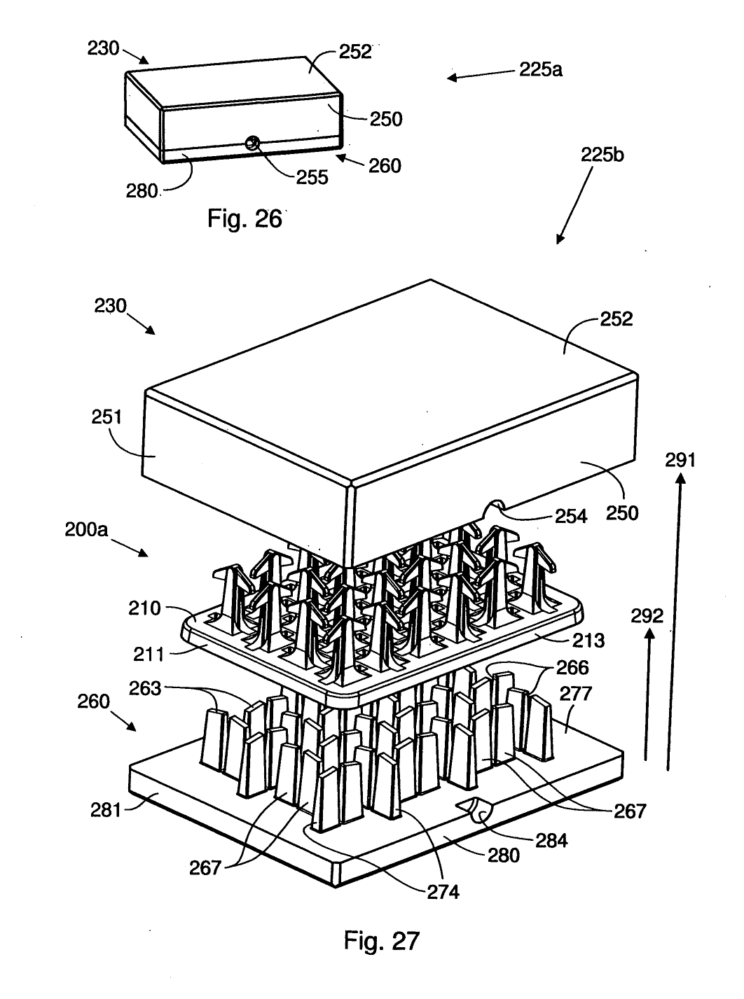

FIG. 26 illustrates a moulding unit for manufacturing a cable fixture device in accordance with the embodiment illustrated in FIGS. 19 to 23. The moulding unit (225a) includes a moving top-mould part (230) and a fixed bottom-mould part (260), the moving top-mould part (230) and the fixed bottom-mould part (260) are closed to form a cavity corresponding to the cable fixture device. The cable fixture device is made by the process of injection moulding. Plastic material is injected into the cavity through an inlet (255). The moulding unit (225a, 225b) shows only the vital parts of the complete moulding machine. Those skilled in the art will appreciate that the moulding unit (225a, 225b) may include all or even a fewer number of components than the components shown in FIG. 26. Further, those ordinarily skilled in the art will understand that the moulding unit (225a, 225b) may include additional components that are not shown here but are not germane to the operation of the moulding unit (225a, 225b) in accordance with the inventive arrangements. Further, in an arrangement, the moving top-mould part is clamped to a moving plate of an injection moulding machine. Similarly, the fixed bottom-mould part is clamped to a fixed plate of the injection moulding machine. Further, either or both of the moving top-mould part and the bottom-mould part can have ejector pins to aid the release of the moulded cable fixture device.

FIGS. 27 and 28 illustrates an exploded view of moulding unit (225a, 225b) for manufacturing of the cable fixture device with the embodiment illustrated in FIGS. 19 to 23. The moulding unit (225a, 225b) can be used to manufacture the cable fixture device (200a) through injection moulding process. The process involves mating the moving top-mould part and fixed bottom-mould part to define a cavity. The cavity corresponds to the shape of the cable fixture device to be formed. The plastic material is then injected in to the cavity. Examples of material include, but are not limited to, polyethylene (PE), polypropylene (PP), vinyl chloride polymers (PVC), polycarbonates (PC), polyethylene terephthalate (PET), acrylonitrile butadiene styrene (ABS), and polyamide (PA). The moulding unit is then opened by moving at least one of the moving top-mould part and fixed bottom-mould part after the cable fixture device is formed.

The cable fixture device (200a) is made by injection moulding of the plastic material through the first part of the inlet represented by two half-holes (254,284). The cable fixture device is shown to eject in the direction (292) after the completion of moulding process. The fixed mould part (260) part is provided with holes (not shown) for ejector pins, that ensures correct ejection of the moulded cable fixture device (200a) from the opened moulding unit (225b), before the moulding unit (225a, 225b) begins its closing sequence for moulding a new cable fixture device.

When a new cable fixture plate (200a) is ready for moulding, the moulding unit (225b) cavity is empty. The moulding unit (225b) is closed by moving the moving top-mould part (230) towards the fixed bottom-mould part (260). The characteristic columns, of the bottom-mould part (260) defined by the surfaces (263, 266, 267, 274), lead to the formation of holes the holes (209) in the cable fixture device. The surfaces (203, 206, 207, 214, 217), in the cable fixture device, are made by the corresponding surfaces (263, 266, 267, 274, 277) of the characteristic columns. The plastic material is injected through an inlet (255).

After the cable fixture device is formed, the moving top-mould part (230) and the fixed bottom-mould part (260) are moved relative to each other to facilitate the removal of the formed cable fixture device. The cable fixture device is ejected from the moulding unit (225a) with the help of ejector pins (not shown in Fig.). After the cable fixture device is ejected, the moving top-mould part (230) and fixed bottom-mould part (260) can be again moved relative to each other to close the moulding unit for the next moulding cycle.

The abovementioned specifications and the attached drawings illustrate some embodiments of the head elements including, but not limiting to, a star shaped head, a hemispherical head and a T-shaped head. However, it will be readily apparent to those with ordinary skill in the art that the disclosed embodiments can also be practised with head elements that have other shapes than those illustrated in the drawings and the abovementioned specifications.

The disclosed embodiments provide various advantages. The disclosed embodiments provide a cable fixture device for coiling up the excess length of cable element. Further, the mounting and dismounting of the cable element does not necessarily require a force to be applied in a direction that is perpendicular to the cable fixture device. The disclosed embodiments enable mounting and dismounting by applying a force in a direction that is parallel to the cable fixture device making it easy to route cable element under most circumstances.

The disclosed embodiments allow the cable element to enter and exit the cable fixture at any point along the perimeter of the cable fixture plate. Further, multiple cable elements can be simultaneously routed through the cable fixture device. Moreover, the cable fixture device allows for non-planar routing of the cable elements.

The invented cable fixture device can absorb vibrations and mechanical impacts and allows dissipation of heat from the cable elements. Further, in an embodiment, the cable fixture device does not get statically charged, thereby, preventing the occurrence of electrical shocks.

The foregoing description of the disclosed embodiments have been presented for purpose of illustration and description. It is not intended to be exhaustive or to limit the invention to the precise form disclosed, and other modifications and variations may be possible in light of the above teachings. The embodiments was chosen and described in order to best explain the principles of the disclosed embodiments and its practical application to thereby enable others skilled in the art to best utilize the disclosed embodiments in various embodiments and various modifications as are suited to the particular use contemplated. It is intended that the appended claims be construed to include other alternative embodiments except insofar as limited by the prior art.

1. A cable fixture device for routing at least one cable element from a first location on the cable fixture device to a second location on the cable fixture device, characterized in that the cable fixture device comprising:
a strip element; and
a plurality of pin elements disposed on at least one surface of the strip element,
wherein each of the plurality of pin elements comprising a stem element and a head element, and wherein the stem element of the each pin element is attached to the strip element, and wherein a height of the stem element of each pin element is at least equal to a diameter of the at least one cable element, and wherein the each pin element is capable of elastic deformation, and wherein a gap between a first stem element corresponding to a first pin element and an adjacent stem element corresponding to an adjacent pin element is at least equal to a diameter of the at least one cable element, and wherein a gap between a first head element corresponding to the first pin element and an adjacent head element corresponding to the adjacent pin element is less than the diameter of the at least one cable element, and wherein the at least one cable element is routed between the first pin element and the adjacent pin element, and wherein the first head element and the adjacent head element prevent disengagement of the at least one cable element from the cable fixture device.

2. The cable fixture device according to claim 1, wherein the plurality of pin elements are disposed on the strip element in a two dimensional array.

3. The cable fixture device according to claim 1, wherein a material for the plurality of pin elements is resiliently deformable.

4. The cable fixture device according to claim 1, wherein a material for the strip element is resiliently deformable.

5. The cable fixture device according to claim 1, wherein a material for the cable fixture device is transparent.

6. The cable fixture device according to claim 1, wherein a material for the pin element is selected from the group comprising polyethylene (PE), polypropylene (PP), polyvinyl chloride (PVC), polycarbonates (PC), polyethylene terephthalate (PET), acrylonitrile butadiene styrene (ABS), and polyamide (PA).

7. The cable fixture device according to claim 1, wherein the head element of the each pin element is symmetrical with respect to an axis of the stem element of the each pin element.

8. The cable fixture device according to claim 1, wherein the head element of at least one of the plurality of pin elements is mushroom-shaped.

9. The cable fixture device according to claim 1, wherein the head element of at least one of the plurality of pin elements is hemispherical.

10. The cable fixture device according to claim 1, wherein the head element of at least one of the plurality of pin elements is cross-shaped.

11. The cable fixture device according to claim 1, wherein the head element of at least one of the plurality of pin elements is T-shaped.

12. The cable fixture device according to claim 1, wherein the stem element of at least one of the plurality of pin elements is cylindrical.

13. The cable fixture device according to claim 1, wherein the plurality of pin elements are permanently attached to the strip element.

14. The cable fixture device according to claim 1, wherein at least one of plurality of the pin element comprises two cylindrical stem elements with hemispherical head elements.

15. The cable fixture device according to claim 1, wherein the cable element is a cable used in electrical installations.

16. The cable fixture device according to claim 1, further comprising a means for attaching the strip element to a surface.

17. The cable fixture device according to claim 16, wherein the means for attaching the strip element to a surface is selected from the group comprising screws, bolts, snaps, hook and loop fasteners, adhesives, silicone tapes, clips and nails.

18. The cable fixture device according to claim 1 further comprising an adhesive layer on a back surface of the strip element for attaching the strip element to a surface, wherein the back surface is free of the plurality of pin elements.

19. The cable fixture device according to claim 1, wherein the cable fixture device is deformed in to conform to a non-planar surface.

20. The cable fixture device according to claim 1, wherein the cable fixture device facilitates non-planar routing of the cable element.

21. The cable fixture device according to claim 1, wherein a height of the plurality of pin elements ranges from 1 millimetre (mm) to 100 mm.

22. The cable fixture device according to claim 1, wherein the ratio of a height of the each pin element to a diameter of the stem element of the each pin element ranges from 1:1 to 10:1.

23. The cable fixture plate according to claim 1, wherein the cable fixture device is used for routing the at least one cable of a computer system.

24. A method for manufacturing a cable fixture device, the cable fixture device comprising a strip element and a plurality of pin elements disposed on at least one surface of the strip element, each of the plurality of pin elements comprising a stem element and a head element, the method comprising:
placing the strip element, wherein the strip element is oriented along a first plane; mating a first mould part and second mould part at a mating plane to define a cavity on at least one surface of the strip element, wherein the mating plane is substantially perpendicular to the first plane, and wherein the cavity corresponds to a shape of at least one of the plurality of pin elements;
injecting a molten material in to the cavity; and
disengaging the first mould part and second mould part by moving at least one of the first mould part and second mould part when the at least one pin element is formed on the strip element.

25. A method for manufacturing a cable fixture device, the cable fixture device comprising a strip element and a plurality of pin elements disposed on at least one surface of the strip element, each of the plurality of pin elements comprising a stem element and a head element, the method comprising
mating of the moving top-mould part and the fixed bottom-mould part to define cavity where the moving top-mould part is responsible for forming the cable fixture device on top surface and the fixed bottom-mould part is responsible for forming the bottom surface of the cable fixture device and wherein the cavity corresponds to the shape of the cable fixture device;
injecting a molten material in to the cavity, and
disengaging the moving top-mould part and fixed bottom-mould part by moving at least one of the moving top-mould part and fixed bottom-mould part when the cable fixture device is formed.
